(19) United States
(12) Patent Application Publication
(10) Pub. No.: US 2026/0349187 A1
(43) Pub. Date: Nov. 5, 2026

(54) MPO DUSTCAP WITH BUILT-IN CLEANER

(71) Applicant: Clearfield, Inc., Minneapolis, MN (US)

(72) Inventors: John P. Hill, Oak Grove, MN (US); William J. Cruzen, Monticello, MN (US)

(21) Appl. No.: 19/290,831

(22) Filed: Aug. 5, 2025

Related U.S. Application Data
(63) Continuation-in-part of application No. 19/196,135, filed on May 1, 2025.

(51) Int. Cl. G02B 6/38

(52) U.S. Cl. CPC G02B 6/3866; G02B 6/3849

(57) ABSTRACT

A dustcap with connector apertures at both ends. The first end is configured to couple with and cover a multi-fiber push-on (MPO) connector, for example, during storage and transport. The second end has a built-in cleaner covered by a removable foil. Prior to installation of the optical fiber, the foil can be removed and the MPO connector can be pressed into the second end so that the ends of optical fibers contact the cleaner to remove any debris from the ends of the optical fibers. The second end includes one or more keyed alignment features configured to facilitate insertion of the optical fiber connector in a controlled orientation so that an angled end face of the optical fiber connector uniformly contacts the cleaner.

### CROSS REFERENCE TO RELATED APPLICATIONS

This application is a continuation-in-part under 37 C.F.R. 1.53(b) claiming priority to U.S. Patent Application No. 19/196,135, filed May 1, 2025, the contents of which are hereby incorporated by reference in their entirety as if presented herein in full.

### TECHNICAL FIELD

The disclosed technology relates generally to optical fiber systems and more specifically to Multiple-fiber-Push-On (MPO) dustcaps with keyed cleaners for Angled Physical Contact (APC) optical fiber connectors.

### BACKGROUND

Optical fibers are utilized in many communication networks to transmit information from a source device to a destination device. Within the network, additional connections or couplings may be added to adjust the fiber length or create termination ports for branching fibers to end users.

To interconnect optical fiber cables, various low-loss, stable connectors are used, including SC, Dual LC, LC, ST, and MPO types. These connectors typically align ferrules—each containing an optical fiber end—so that light can pass across the junction.

When light travels through an optical fiber and encounters the end face of a connector, a portion of the light can be reflected back towards the source. For example, in a connector with a flat end-face, this reflected light can travel directly back along the fiber core, potentially interfering with the outgoing signal and degrading network performance. Therefore, many modern MPO connectors utilize APC with an 8-degree angle on the fiber end face to redirect the reflected light away from the fiber core and into the cladding where it is attenuated. This reduces the amount of light that travels back towards the light source, minimizing signal interference and ensuring better network performance, especially crucial for sensitive applications like those using singlemode fiber. However, dirt or contamination on a ferrule end can block or scatter light, which can create loss and degrade performance. Therefore, inspecting and cleaning optical fiber connectors is essential for maintaining high-quality installations. A need exists for tools that can simplify the connector ferrule cleaning process for MPO optical fiber connectors that utilize angled physical contact.

### BRIEF SUMMARY

Certain implementation of the disclosed technology provide a compact, economical, dustcap with an integrated ferrule cleaner that can address the above-referenced needs. The dustcap can include two opposing ends separated by an internal divider wall, each end having apertures and cavities configured to couple with a corresponding Multiple-fiber-Push-On (MPO) Angled Physical Contact (APC) optical fiber connector ends. The aperture and cavity of the first end may be configured to couple with the connector to act as a protective dustcap, for example, during storage and transport. The aperture and cavity of the second end can include a keyed alignment feature configured to facilitate insertion of the optical fiber connector in a controlled orientation. The second end includes a built-in tape cleaner disposed on the internal divider wall, with the aperture of the second end covered by a removable foil, for example, to prevent debris from entering the cavity at the second end. The cleaner is configured to contact an angled end face of the optical fiber connector at an angle substantially perpendicular to the angled end face when the optical fiber connector is inserted into the second cavity. Prior to installation of the optical fiber, the foil can be removed and the MPO APC connector can be pressed into the second end cavity so that the angled end face of the MPO APC connector will substantially uniformly contact the tape cleaner to facilitate removal of any debris from the ends of the optical fibers and/or end face of the MPO APC connector.

In accordance with certain exemplary implementations of the disclosed technology, a dustcap having a body is provided. The body includes a storage connection portion having a first cavity configured to couple to an optical fiber connector and a cleaner connection portion opposite the storage connection portion. The cleaner connection portion includes a second cavity configured to couple to the optical fiber connector, the second cavity having one or more keyed alignment features configured to facilitate insertion of the optical fiber connector in a controlled orientation. A cleaner disposed within the cleaner connection portion. The cleaner is configured to contact an angled end face of the optical fiber connector at an angle substantially perpendicular to the angled end face when the optical fiber connector is inserted into the second cavity. A sealing cover is configured to removably couple to and cover the second cavity of the cleaner connection portion.

In certain implementations, a method is provided. The method includes providing a dustcap having a body comprising a cleaner connection portion defining a cavity configured to couple to an optical fiber connector, wherein the cleaner connection portion includes one or more keyed alignment features configured to facilitate insertion of the optical fiber connector into the cavity in a controlled orientation. A cleaner is disposed within the cleaner connection portion wherein the cleaner is configured to contact an angled end face of the optical fiber connector at an angle substantially perpendicular to the angled end face when the optical fiber connector is inserted into the cavity. A sealing cover is configured to removably couple to and cover the cavity of the cleaner connection portion. The method includes removing the sealing cover, inserting the optical fiber connector into the cavity until the angled end face of the optical fiber connector contacts the cleaner, wherein the inserting is guided by the one or more keyed alignment features; and removing the optical fiber connector from the dustcap.

The disclosed technology is not limited in terms of the particular example implementations described in this application, which are intended as illustrations of various aspects. Many modifications and variations can be made without departing from its spirit and scope, as will be apparent to those skilled in the art.

### BRIEF DESCRIPTION OF THE FIGURES

FIG. 1 is a perspective view of a dustcap in a first storage position prior to being installed or after being removed from an optical fiber connector, in accordance with certain exemplary implementations of the disclosed technology. A side-view of the end of an MPO APC connector illustrating the angled end face of the connector is shown in the inset drawing.

FIG. 2 is an exploded perspective view of the dustcap (as shown in FIG. 1) including a cleaner, keyed alignment feature, and a sealing cover, in accordance with certain exemplary implementations of the disclosed technology.

FIG. 3A is an example top view of the dustcap from the cleaner connection portion end.

FIG. 3B is an example first side view of the dustcap, consistent with certain implementations of the disclosed technology.

FIG. 3C is an example second side view of the dustcap, consistent with certain implementations of the disclosed technology.

FIGS. 4A-4F illustrate various perspective views of the dustcap relative to an optical fiber connector at different stages of use.

FIG. 4A illustrates a storage connection portion of the dustcap coupled to the optical fiber connector, for example, for use during storage and/or transport.

FIG. 4B illustrates removal of the dustcap from the optical fiber connector.

FIG. 4C illustrates a removal of a first portion of the sealing cover from the cleaner connection portion of the dustcap.

FIG. 4D illustrates a removal of a second portion of the sealing cover from the cleaner connection portion of the dustcap.

FIG. 4E illustrates rotation of the dustcap by 180 degrees so that the cleaner connection portion of the dustcap is ready to couple with the end of the optical fiber connector.

FIG. 4F illustrates a coupling of the cleaner connection portion of the dustcap with the end of the optical fiber connector, which causes the end of the ferrule(s) of the optical fiber connector to come in contact with the cleaner disposed in the base (or divider) of the dustcap in the cleaner connection portion to remove any debris from the end of the ferrule(s), in accordance with certain exemplary implementations of the disclosed technology.

FIG. 5 is a flow diagram illustrating a method for using the dustcap, according to aspects of the disclosed technology.

### DETAILED DESCRIPTION

Cleaning fiber optic connectors and ferrules is essential to providing reliable optical fiber connections. The disclosed technology includes a dustcap with a built-in cleaner for optical fiber connectors and ferrules. The dustcap can include two opposing ends, each end having apertures and cavities configured to couple with a corresponding Multiple-fiber-Push-On (MPO) Angled Physical Contact (APC) connector end and associated ferrules. In certain implementations, the cavities of the two opposing ends may be separated by an internal divider wall. The aperture and cavity of the first end may be configured to couple with the connector to act as a protective dustcap, for example, during storage and transport. The aperture and cavity of the second end can include a built-in tape cleaner disposed on the internal divider wall, with the aperture of the second end covered by a removable foil, for example, to prevent debris from entering the cavity at the second end. Prior to installation of the optical fiber, the foil can be removed and the MPO connector can be pressed into the second end cavity so that the ends of optical fibers on the MPO ferrule contact the tape cleaner to remove any debris from the ends of the optical fibers.

Example implementations of the disclosed technology may provide an easy and convenient way to clean an optical fiber connector and ferrule using a cleaner embedded within the dustcap, for example, before plugging the connector into a component of an optical fiber network. Example implementations of the dustcaps disclosed herein may be configured for use with different types of connectors and ferrules, including but not limited to SC, Dual LC, LC, ST and MPO connectors. Various example implementations may be configured to receive either a ferrule or a portion of an optical fiber connector. Example implementations may also be used conveniently in the field at any network location. The dustcap with the built-in cleaner may be provided separately or as a component of an optical fiber connector or adapter. Example implementations thus simplify the connector cleaning process, thereby simplifying deployment and repair of connectors, and improving network reliability.

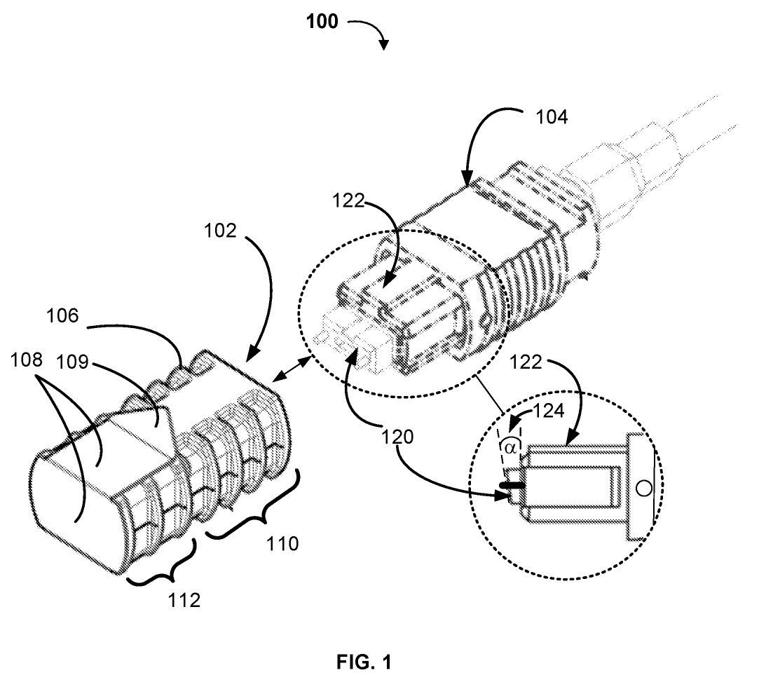

FIG. 1 is a perspective view of a dustcap 102 in a first storage position prior to being installed on (or after being removed from) an optical fiber connector 104, in accordance with certain exemplary implementations of the disclosed technology. The dustcap 102 includes a body 106 that includes a storage connection portion 110 in communication with a first end that defines a first cavity that the optical fiber connector 104 can be inserted into to retain the dustcap 102, for example, for protection of the ferrule(s) during storage or transport.

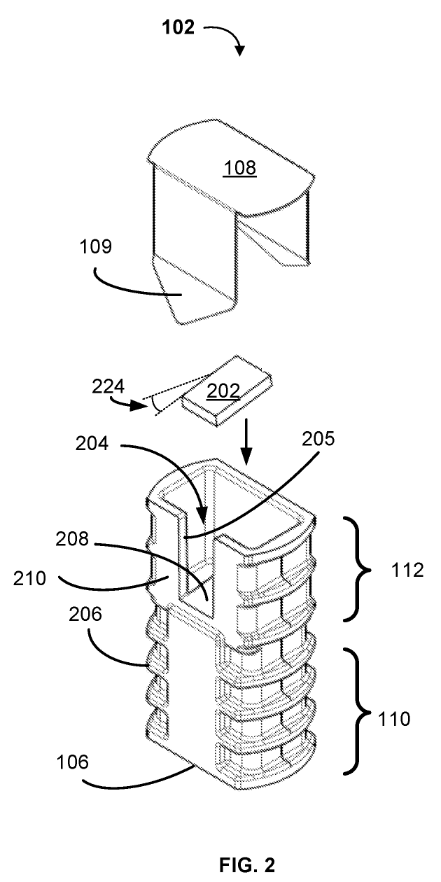

In accordance with certain exemplary implementations of the disclosed technology, the body 106 of the dustcap 102 can include a cleaner connection portion 112 in communication with a second end of the dustcap 102 that defines a second cavity. The cavity opening of the cleaner connection portion 112 may be covered with a removable sealing cover 108, such as a foil, to removably couple to and cover the second cavity of the cleaner connection portion. The sealing cover 108 can include one or more wings 109 or pull tabs to facilitate removal. In certain implementations, the wings 109 may be an integral part of the sealing cover 108. On other implementations the wings 109 may be attached to the sealing cover 108. As will be discussed below with respect to FIG. 2, the cleaner connection portion 112 may include a cleaner disposed within the second cavity.

In accordance with certain exemplary implementations of the disclosed technology, the optical fiber connector 104 may be configured with an Angled Physical Contact (APC) end face 120. In certain implementations, the end face 120 may be characterized by an angle 124 of approximately 8 degrees, for example (see inset diagram). Other angles 124 may be used without departing from the scope of the disclosed technology. To ensure that the connector 104 is inserted into the cleaner connection portion 112 (and/or the storage connection portion 110) of the dustcap 102 in the proper orientation, one or more key features 122 may be utilized, as will be further discussed below with respect to FIG. 2.

In certain implementations, the removable sealing cover 108 may have a sticky adhesive on predetermined areas (for example, one side, or on one side except on the wings 109) that will allow it to be attached to the body 106, for example, to seal the second cavity from the environment, but that will allow easy removal for insertion of the optical fiber connector 104.

FIG. 2 is an exploded perspective view of the dustcap 102 (as shown in FIG. 1) including a cleaner 202 (shown uninstalled) and the sealing cover 108 (shown uninstalled or removed), in accordance with certain exemplary implementations of the disclosed technology. The cleaner connection portion 112 may include a cavity 204 having a keyed alignment feature 205 defined in a sidewall of the cleaner connection portion 112, for example, to facilitate insertion and alignment of the optical fiber connector 104 (not shown in FIGS. 2, see 1) into the cleaner connection portion 112 and guided by the one or more key features 122 of the connector (see FIG. 1) coupled with the keyed alignment feature 205 of the dustcap 102 so that the angled portion of the end face (see end face 120 in FIG. 1) of the optical fiber connector 104 enters the cavity 204 in a controlled orientation.

In certain implementations, the cleaner 202 and/or a portion of the divider wall 208 may be configured so that the cleaner 202 is tilted at an angle 224 that is substantially equivalent to the angle 124 of the end face 120 of the optical fiber connector 104 (not shown in FIGS. 2, see 1).

In certain implementations, rather than angling the cleaner 202 or divider wall 208, the cleaner connection portion 112 of the dustcap 102 may be angled (for example at an angle 224) with respect to the divider wall 208 to achieve similar uniform contact of the end face 120 with the surface of the cleaner 202.

In yet other example implementations, rather than angling the cleaner 202, the divider wall 208, or the cleaner connection portion 112, the cleaner 202 may be characterized with a thickness and compressibility that enables the angled portion of the end face 120 of the optical fiber connector 104 (see FIG. 1) to at least temporarily deform the cleaner 202 when the optical fiber is inserted into the cavity 204 so that the cleaner 202 uniformly contacts the end face 120 to remove any debris from the end face upon removing the connector 104 from the cavity.

In accordance with certain exemplary implementations of the disclosed technology, the cleaner 202 can include a tape material, for example, having a sticky or tacky surface that, when contacted with a dirty end of a connector, will trap and retain debris from the ferrule ends, effectively cleaning the ferrule ends without transferring any significant amount of residue from the tacky surface to the ferrule ends. In certain implementations, the cleaner can include sticky/tacky material on both sides (i.e., double sided tape) so that the cleaner 202 can be easily mounted to a divider wall 208 at the bottom of the cavity 204. In certain implementations, the cleaner may include an internal layer that is compressible to allow for various tolerances and/or to prevent damaging of the ferrule ends.

In certain implementations, one or more side faces of the body 106 corresponding to the cleaner connection portion 112 may include one or more flat portions 210 to provide a surface for which the sealing cover 108 can be attached to seal and protect the cavity 204 and cleaner 202 from collecting debris.

In certain implementations, the dustcap 102 can include grip ridges 206 integrated into the body to facilitate pushing the dustcap 102 onto the end of the optical fiber connector 104 or pulling it off by hand. In certain implementations, the grip ridges 206 on the storage connection portion 110 may extend around the edges of the body 106, as shown, while the grip ridges 206 on the cleaner connection portion 112 may terminate closer to the edges to allow definition of the flat portion(s) 210 to couple with the sealing cover 108.

In accordance with certain exemplary implementations of the disclosed technology, and as mentioned above, a divider wall 208 may be disposed between the storage connection portion 110 and the cleaner connection portion 112 and may be configured as a mounting base for which the cleaner 202 may be securely attached. The positioning of the divider wall 208 may be set so that when the cleaner 202 is attached to the divider wall 208 and an optical fiber connector is firmly inserted into the cavity 204, the ferrule end(s) of the optical fiber connector touch the top surface of the cleaner 202 so that the sticky/tacky material on the surface of the cleaner 202 can contact and remove debris from the ferrule ends. In certain implementations, and as mentioned above, the cleaner 202 can include a compressible internal layer having a thickness that may be accounted for in the positioning of the divider wall 208.

In accordance with certain exemplary implementations of the disclosed technology, the cleaner 202 may be flat and may be characterized by a rectangular shape that matches that of the dimensions of the cavity 204. However, in other example implementations, the cleaner may be shaped differently, and the body 106 or divider wall 208 may have a receptacle rather than a flat surface for receiving the cleaner 202. Other shapes and arrangements of the body of the cleaner assembly and the cleaner are also within the scope of this disclosure.

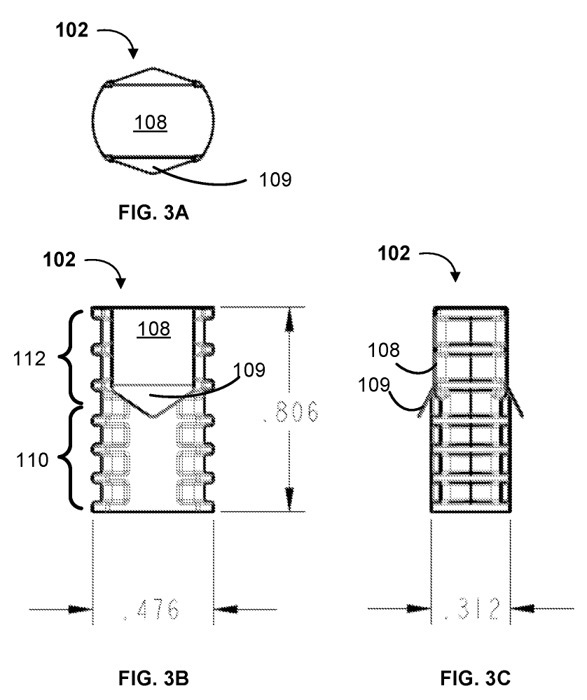

FIG. 3A is an example top view of the dustcap 102 showing the sealing cover 108 from the cleaner connection portion end. FIG. 3B is an example first side view of the dustcap 102, consistent with certain implementations of the disclosed technology, with example dimensions (in inches). FIG. 3C is an example second side view of the dustcap 102, showing an example configuration of the wings 109 for easy removal of the sealing cover 108, in accordance with certain exemplary implementations of the disclosed technology.

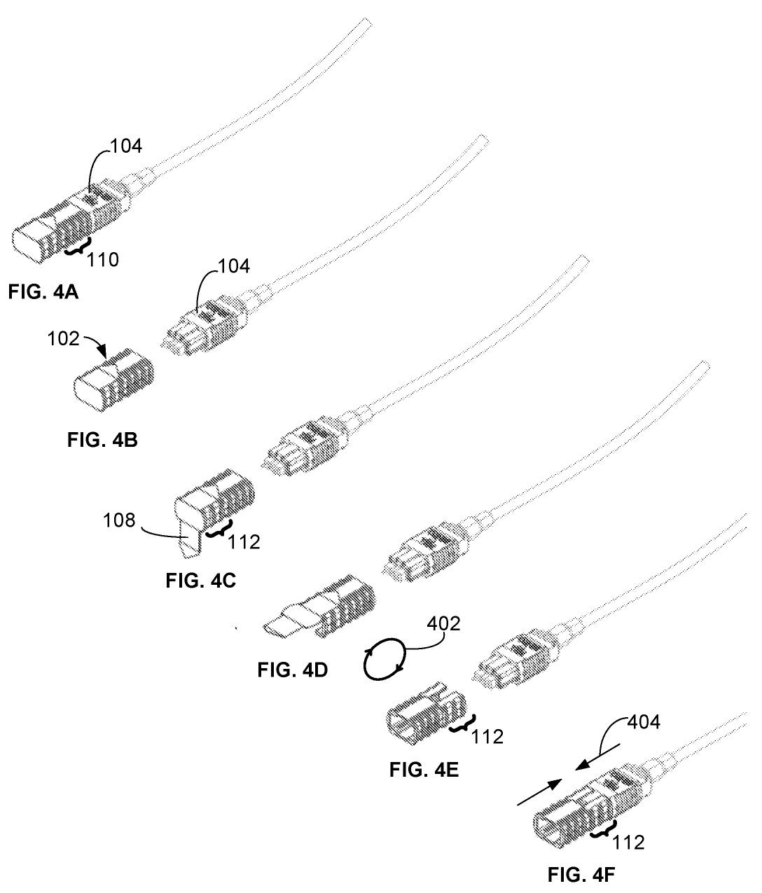

FIGS. 4A-4F illustrate various perspective views of the dustcap 102 relative to an optical fiber connector 104 at different example stages of use. FIG. 4A illustrates use, for example, during storage and/or transport in which the storage connection portion 110 of the dustcap is coupled to the optical fiber connector 104. FIG. 4B illustrates removal of the dustcap 102 from the optical fiber connector 104, for example, prior to cleaning the ferrule(s) of the connector 104. FIG. 4C illustrates a removal of a first portion of the sealing cover 108 from the cleaner connection portion 112 of the dustcap 102. FIG. 4D illustrates a removal of a second portion of the sealing cover 108 from the cleaner connection portion 112 of the dustcap 102. FIG. 4E illustrates rotation 402 of the dustcap 102 by 180 degrees so that the cleaner connection portion 112 of the dustcap 102 is ready to couple with the end of the optical fiber connector 104. FIG. 4F illustrates a coupling 404 of the cleaner connection portion 112 of the dustcap 102 with the end of the optical fiber connector 104, which causes the end of the ferrule(s) of the optical fiber connector 104 to come in contact with the cleaner disposed in the base (or divider) of the dustcap in the cleaner connection portion to remove any debris from the end of the ferrule(s), in accordance with certain exemplary implementations of the disclosed technology.

Referring again to FIG. 2, and in accordance with certain exemplary implementations of the disclosed technology, the body 106 of the dustcap 102 may be an integral piece or may comprise, for example, a base portion and an attached flip lid (not shown) in addition or instead of the sealing cover 108. The body 106 can include a receptacle configured to receive the cleaner 202. The receptacle may be configured with a depth exceeding that of the cleaner 202, such that some space remains above the cleaner within the receptacle. In other example implementations, the receptacle may be sized to match the size of the cleaner, or the cleaner may extend beyond the depth of the receptacle.

In accordance with certain implementations of the disclosed technology, the alignment feature 205 may be configured to align the (ferrule) end of an inserted optical fiber connector perpendicularly to a surface of the cleaner 202. The aperture of the alignment feature 205 can have an internal diameter that is approximately equal to or slightly greater than an outer diameter of the corresponding tab or key feature 122 of optical fiber connector ferrule or body. Accordingly, the alignment feature 205 can provide an alignment guide for controlling an orientation of the optical fiber connector 104 into the cleaner cavity 204 of the dustcap 102, helping to facilitate contact between the end of the optical fiber connector 104 and the surface of the cleaner 202. This can limit the orientation of the angled end face 120 of the connector 104 to be inserted into the cavity 204 such that the angled end face 120 is perpendicular (or substantially perpendicular) to the surface of the cleaner 202, thereby causing substantially all of the end surface(s) of the end face to contact the cleaner 202. By increasing the completeness of this contact between the connector end face and the cleaner 202, it is possible to increase the first-attempt clean rate of the ferrule, thereby providing significant increases in the quality of a fiber installation.

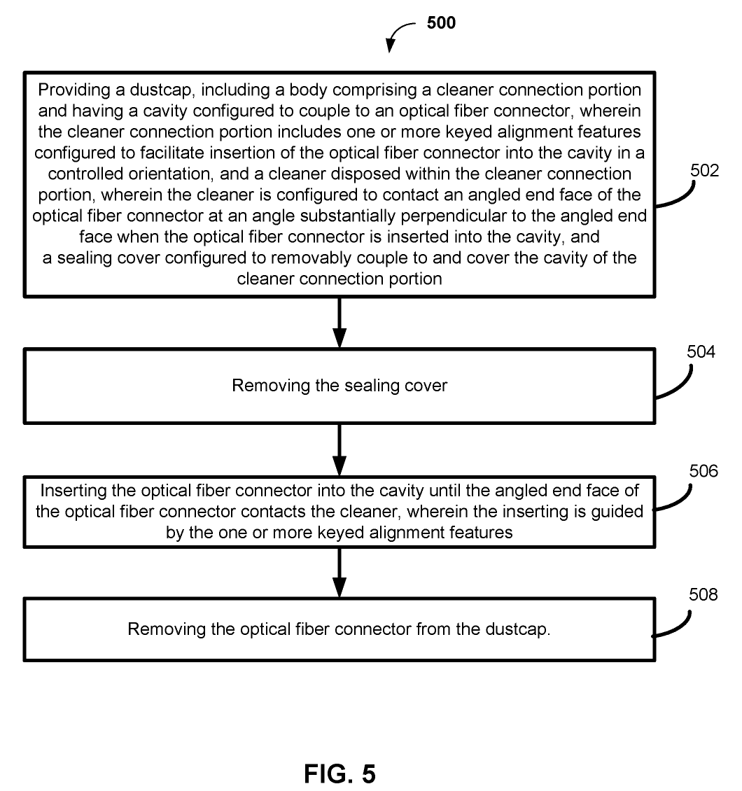

FIG. 5 is a flow diagram illustrating a method 500 for using the dustcap, according to aspects of the disclosed technology. In block 502, the method 500 includes providing a dustcap, including a body comprising a cleaner connection portion and having a cavity configured to couple to an optical fiber connector, wherein the cleaner connection portion includes one or more keyed alignment features configured to facilitate insertion of the optical fiber connector into the cavity in a controlled orientation, and a cleaner disposed within the cleaner connection portion, wherein the cleaner is configured to contact an angled end face of the optical fiber connector at an angle substantially perpendicular to the angled end face when the optical fiber connector is inserted into the cavity, and a sealing cover configured to removably couple to and cover the cavity of the cleaner connection portion. In block 504, the method 500 includes removing the sealing cover. In block 506, the method 500 includes inserting the optical fiber connector into the cavity until the angled end face of the optical fiber connector contacts the cleaner, wherein the inserting is guided by the one or more keyed alignment features. In block 508, the method includes removing the optical fiber connector from the dustcap.

In certain implementations, the cleaner can include double-sided tape mounted to a divider between a storage connection portion and the cleaner connection portion of the body.

In accordance with certain exemplary implementations of the disclosed technology, the one or more keyed alignment features in the cleaner connection portion may be configured to mate with corresponding features on the optical fiber connector to ensure proper orientation of the angled end face relative to the cleaner.

In certain implementations, the one or more keyed alignment features may be configured to snap attach to the optical fiber connector.

In certain implementations, the one or more keyed alignment features may be configured to align an end face of the optical fiber connector perpendicularly to a surface of the cleaner.

In certain implementations, the optical fiber connector may be a Multiple-fiber-Push-On (MPO) connector. In certain implementations, the MPO connector may be an Angled Physical Contact (APC) connector.

In certain implementations, the body can include one or more grip protrusion on one or more outer walls of the body to facilitate insertion and removal of the optical fiber connector.

In certain implementations, the cleaner can include a compressible layer. The compressible layer may be configured to deform upon contact with the angled end face of the optical fiber connector to uniformly contact the angled end face during cleaning.

Certain implementations can include inserting the optical fiber connector into a storage connection portion of the dustcap for storage or transport.

In certain implementations, the body of the dustcap can include a plurality of grip protrusion on one or more outer walls of the body.

In certain implementations, the cleaner may be configured to contact ferrule ends of the optical fiber connector when the optical fiber connector is inserted into the second cavity.

In certain implementations, the angled end face of the optical fiber connector may be characterized by an angle of approximately 8 degrees relative to a plane perpendicular to a longitudinal axis of the optical fiber connector.

In certain implementations, the cleaner can include double sided tape.

In certain implementations, the cleaner can include a compressible. The compressible layer may be configured to deform upon contact with the angled end face of the optical fiber connector to uniformly contact the angled end face during cleaning.

In certain implementations, the body of the dustcap can include a divider between the storage connection portion and the cleaner connection portion of the body.

In certain implementations, the cleaner may be disposed on the divider. In certain implementations, the cleaner or the divider may be tilted at an angle substantially equivalent to the angle of the angled end face of the optical fiber connector.

In certain implementations, the one or more keyed alignment features in the cleaner connection portion may be configured to mate with corresponding features on the optical fiber connector to ensure proper orientation of the angled end face relative to the cleaner.

In certain implementations, the one or more keyed alignment features may be configured to snap attach to the optical fiber connector.

In certain implementations, the one or more keyed alignment features may be defined in a sidewall of the cleaner connection portion.

In the above detailed description, reference is made to the accompanying drawings, which form a part hereof. In the drawings, similar symbols typically identify similar components, unless context dictates otherwise. The illustrative example implementations described in the detailed description, drawings, and claims are not meant to be limiting. Other example implementations may be used, and other changes may be made, without departing from the spirit or scope of the subject matter presented herein. It will be readily understood that the aspects of the disclosed technology, as generally described herein, and illustrated in the Figures, can be arranged, substituted, combined, separated, and designed in a wide variety of different configurations, all of which are explicitly contemplated herein.

The disclosed technology is not to be limited in terms of the particular example implementations described herein, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The disclosed technology is to be limited only by the terms of the appended claims, along with the full scope of equivalents to which such claims are entitled. It is to be understood that the terminology used herein is for the purpose of describing particular example implementations only, and is not intended to be limiting. Certain examples and implementations of the disclosed technology are described above with reference to block and flow diagrams according to examples of the disclosed technology. It will be understood some blocks of the block diagrams and flow diagrams do not necessarily need to be performed in the order presented, can be repeated, or do not necessarily need to be performed at all, according to some examples or implementations of the disclosed technology. It is also to be understood that the mention of one or more method steps does not preclude the presence of additional method steps or intervening method steps between those steps expressly identified. Additionally, method steps from one process flow diagram or block diagram can be combined with method steps from another process diagram or block diagram. These combinations and/or modifications are contemplated herein.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the example implementations described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to example implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed example implementations.

We claim:

1. A dustcap comprising:
a body comprising:
a storage connection portion having a first cavity configured to couple to an optical fiber connector; and
a cleaner connection portion opposite the storage connection portion and having a second cavity configured to couple to the optical fiber connector, wherein the second cavity includes one or more keyed alignment features configured to facilitate insertion of the optical fiber connector in a controlled orientation;
a cleaner disposed within the cleaner connection portion, wherein the cleaner is configured to contact an angled end face of the optical fiber connector at an angle substantially perpendicular to the angled end face when the optical fiber connector is inserted into the second cavity; and
a sealing cover configured to removably couple to and cover the second cavity of the cleaner connection portion.

2. The dustcap of claim 1, wherein the cleaner is configured to contact ferrule ends of the optical fiber connector when the optical fiber connector is inserted into the second cavity, and wherein the angled end face of the optical fiber connector is characterized by an angle of approximately 8 degrees relative to a plane perpendicular to a longitudinal axis of the optical fiber connector.

3. The dustcap of claim 1, wherein the optical fiber connector is a Multiple-fiber-Push-On (MPO) connector, and wherein the MPO connector is an Angled Physical Contact (APC) connector.

4. The dustcap of claim 1, wherein the cleaner comprises double sided tape.

5. The dustcap of claim 4, wherein the cleaner comprises a compressible layer, and wherein the compressible layer is configured to deform upon contact with the angled end face of the optical fiber connector to uniformly contact the angled end face during cleaning.

6. The dustcap of claim 1, wherein the body further comprises a divider between the storage connection portion and the cleaner connection portion of the body.

7. The dustcap of claim 6, wherein the cleaner is disposed on the divider, and wherein the cleaner or the divider is tilted at an angle substantially equivalent to the angle of the angled end face of the optical fiber connector.

8. The dustcap of claim 1, wherein the one or more keyed alignment features in the cleaner connection portion are configured to mate with corresponding features on the optical fiber connector to ensure proper orientation of the angled end face relative to the cleaner.

9. The dustcap of claim 8, wherein the one or more keyed alignment features are further configured to snap attach to the optical fiber connector.

10. The dustcap of claim 8, wherein the one or more keyed alignment features are defined in a sidewall of the cleaner connection portion.

11. The dustcap of claim 1, wherein the body comprises a plurality of grip protrusion on one or more outer walls of the body.

12. A method comprising:
providing a dustcap, the dustcap comprising:
a body comprising a cleaner connection portion and having a cavity configured to couple to an optical fiber connector, wherein the cleaner connection portion includes one or more keyed alignment features configured to facilitate insertion of the optical fiber connector into the cavity in a controlled orientation;
a cleaner disposed within the cleaner connection portion, wherein the cleaner is configured to contact an angled end face of the optical fiber connector at an angle substantially perpendicular to the angled end face when the optical fiber connector is inserted into the cavity; and
a sealing cover configured to removably couple to and cover the cavity of the cleaner connection portion;
removing the sealing cover;
inserting the optical fiber connector into the cavity until the angled end face of the optical fiber connector contacts the cleaner, wherein the inserting is guided by the one or more keyed alignment features; and
removing the optical fiber connector from the dustcap.

13. The method of claim 12, wherein the cleaner comprises double-sided tape mounted to a divider between a storage connection portion and the cleaner connection portion of the body.

14. The method of claim 12, wherein the one or more keyed alignment features in the cleaner connection portion are configured to mate with corresponding features on the optical fiber connector to ensure proper orientation of the angled end face relative to the cleaner.

15. The method of claim 14, wherein the one or more keyed alignment features are configured to snap attach to the optical fiber connector.

16. The method of claim 14, wherein the one or more keyed alignment features are configured to align a ferrule of the optical fiber connector perpendicularly to a surface of the cleaner.

17. The method of claim 12, wherein the optical fiber connector is a Multiple-fiber-Push-On (MPO) connector, and wherein the MPO connector is an Angled Physical Contact (APC) connector.

18. The method of claim 12, wherein the body comprises one or more grip protrusions on one or more outer walls of the body to facilitate insertion and removal of the optical fiber connector.

19. The method of claim 12, wherein the cleaner comprises a compressible layer, and wherein the compressible layer is configured to deform upon contact with the angled end face of the optical fiber connector to uniformly contact the angled end face during cleaning.

20. The method of claim 12, further comprising inserting the optical fiber connector into a storage connection portion of the dustcap for storage or transport.
